(19) United States
(12) Patent Application Publication
(10) Pub. No.: US 2023/0078772 A1
(43) Pub. Date: Mar. 16, 2023

(54) MANUFACTURING SYSTEM FOR ADDITIVE MANUFACTURING OF A WORKPIECE

(71) Applicant: UNITED GRINDING GROUP MANAGEMENT AG, Bern (CH)

(72) Inventors: Michael CLOOTS, St. Gallen (CH); Florian WIRTH, St. Gallen (CH); Pascal BRUNNER, Hosenruck (CH); Philipp LAUBER, Egnach (CH); Alex FRAUCHIGER, St. Gallen (CH); Kai GUTKNECHT, Uznach (CH)

(21) Appl. No.: 17/946,133

(22) Filed: Sep. 16, 2022

(30) Foreign Application Priority Data
Sep. 16, 2021 (EP) 21197233.6

(51) Int. Cl. B29C 64/214; B23K 26/03; B23K 26/342; B33Y 10/00; B33Y 30/00; B33Y 50/02; B33Y 40/00; B29C 64/35; B29C 64/393; B29C 64/141

(52) U.S. Cl. CPC B29C 64/214; B23K 26/034; B23K 26/342; B33Y 10/00; B33Y 30/00; B33Y 50/02; B33Y 40/00; B29C 64/35; B29C 64/393; B29C 64/141

(57) ABSTRACT

The present disclosure relates to a manufacturing system for additive manufacturing of a workpiece and an additive manufacturing method. The manufacturing system for additive manufacturing of a workpiece includes a building panel, a lifting device for the building panel, a blade device, an optical device, and a control unit. The blade device comprises at least one coater element for applying or removing a powder material to the building panel. The optical device comprises an optical element for reception of image data from the building panel and/or from the powder layer. The lifting device is configured to raise and/or lower the building panel. The control unit is configured to control the lifting device based on the image data.

### TECHNICAL FIELD

The present disclosure relates to a manufacturing system for additive manufacturing of a workpiece and an additive manufacturing method.

### BACKGROUND

Additive manufacturing, in particular selective laser melting (SLM) or laser powder bed fusion (LPBF), is a generative manufacturing process that belongs to the group of beam fusion processes. In selective laser melting, the material to be processed is deposited in powder form in a thin layer on a base plate. The powdered material is completely remelted locally by means of laser radiation and forms a solid material layer after solidification. The base plate is then lowered by the amount of a layer thickness and powder is applied again. This cycle is repeated until all layers have been remelted. The finished component is cleaned of excess powder and machined according to requirements or used immediately.

Conventional machines for additive manufacturing are often simple in design, so they lack robustness and accuracy compared to precision machine tooling. Moreover, such machine requires time-consuming setup and preparation.

Therefore, the manufacturing system for additive manufacturing of a workpiece can be further improved.

### SUMMARY

It is therefore an object of the present disclosure to provide an improved manufacturing system that increases the productivity of additive manufacturing.

This object is solved by a manufacturing system for additive manufacturing of a workpiece and an additive manufacturing process according to the independent claims. Advantageous embodiments and further embodiments can be found in the subclaims and in the following description.

The present disclosure comprises a manufacturing system for additive manufacturing of a workpiece, comprising a building panel, a lifting device for the building panel, a blade device, an optical device, and a control unit. The blade device comprises at least one coater element for applying or removing a powder material to or from the building panel. The optical device comprises an optical element for reception of image data from the building panel and/or from the powder layer. The lifting device is configured to raise and/or lower the building panel. The control unit is configured to control the lifting device based on the image data.

The advantage of the manufacturing system according to the invention is that a flawless process of additive manufacturing can be ensured. Thus, the productivity of additive manufacturing can be increased. In particular, real-time control of the manufacturing system can be realized by parallel monitoring of the additive manufacturing.

The additive manufacturing system may be designed to manufacture the workpiece by a selective laser melting (SLM) or laser powder bed fusion (LPBF) of a powder material.

The blade device may be located in a build chamber of the manufacturing system. The blade device may be configured to apply a freshly prepared powder material to the building panel and/or remove a residual powder material from the building panel according to a melting process. By moving the blade device, the coater element can move in a horizontal direction relative to the building panel. Preferably, the coater element can be arranged facing a surface of the building panel onto which the powder material is provided.

The coater element can be used, for example, to take the powder material from a powder container and apply it to the building panel in layers. In addition, according to each melting process, the coating element can transport the excess powder material and/or weld spatter, which has been produced during additive manufacturing, into an overflow container.

The coater element may be, for example, a rubber lip, a blade made of metal and/or ceramic, a silicone-impregnated brush, and/or a carbon brush. The coater element may be configured to evenly apply the powder material to the building panel at a predetermined height and to remove the powder residue and/or weld spatter from the building panel without leaving any residue.

The building panel may be located in a building container, for example. The building panel can be used to receive the fresh powder material applied in layers and to allow the selective melting of the powder material there. According to repeated application of the powder material and selective melting, the workpiece can finally be produced.

The building panel may be coupled to the lifting device to allow movement of the building panel, particularly in a vertical direction, within the building container. Preferably, the building panel can be gradually lowered downward by means of the lifting device according to each melting operation or exposure of the laser beam to allow the following melting operation of the reapplied powder material.

For example, the optical element may include an off-axis monitoring device, such as an off-axis camera. The off-axis monitoring device may be designed to monitor a heat distribution of an additively manufactured component layer of the workpiece. The off-axis monitoring device can also be used to detect powder application errors that may occur during a coating process. During powder application, line-like structures can be formed in the direction of travel of the blade device. Visibility of such powder application defects may increase most when illuminated by side lighting to create a shadow. The powder application defect and/or the coating defect can be detected indirectly via a characteristic shadow using the off-axis monitoring device.

The control unit can receive the image data generated by the optical device and integrate emission data occurring and detected during the exposure of a powder coating within an image. The result of this acquisition may correspond to a heat map of the currently built layer. From this heat map, it may be possible to detect thermal irregularities during additive manufacturing and, if this information is processed sufficiently quickly, to already take countermeasures during a subsequent layer. This can be, for example, a dynamic adjustment of exposure sequences of areas to be scanned within a layer, laser powers or a scanning speed within certain scan areas. The control unit can additionally control the movement of the lifting device based on the acquired data and/or the heat map in order to adjust the height of the building panel. In this way, the application quality of the powder material, hence the productivity of additive manufacturing, can be increased.

In one embodiment, the blade device comprises a blade turret having a cylindrical base body, the peripheral surface of which has at least one reception into which the coater element is inserted.

The term turret may be understood to refer to a rotating body that rotates about its longitudinal axis. The rotary body may thus be cylindrically shaped. The cylindrical rotary body or base body may include at least one reception on its peripheral surface. The reception may be shaped, for example, as a groove extending at least partially in the longitudinal direction of the cylindrical base body. The coater element may be frictionally or positively connected into the reception or groove. Alternatively, the reception may be formed as a projection projecting outwardly from the circumferential surface of the cylindrical base body. The coater element can be attached to this projection.

The blade turret may move on the building panel substantially perpendicular to the longitudinal axis of its cylindrical rotating body. In this regard, the blade turret may be configured so that the cylindrical base body does not rotate until the control unit detects an abnormality in the applied powder layer. In other words, a coater element can apply the powder material to the building panel and/or remove it from the building panel until the application quality of the powder material meets a predetermined requirement.

In one embodiment, the blade turret has at least one further reception into which a further coater element can be inserted. The blade turret can have at least one second reception or a plurality of receptions, which are arranged on the circumferential surface of the blade turret at a distance from one another along the circumferential direction.

For example, the control unit may use the optical device to evaluate the application quality of the powder material and detect an error on the currently used coater element if the application quality of the powder material deviates from the predetermined requirement. In the event of the fault, the blade turret can rotate according to the severity of the damage to the current coater element and switch to a next coater element, in particular one that is free of faults.

In this way, a condition of the currently used coater element can be monitored in real time and the defect or damage to the coater element can be immediately repaired. Thus, additive manufacturing can be performed continuously without a pause for repair.

In one embodiment, the blade turret has at least one further reception into which a cleaning element for removing powder residues can be inserted. The cleaning element can be, for example, a conventional brush, silicone-impregnated brush and/or a carbon brush. The cleaning element may be configured to clean a bottom of the build chamber, which may include an interface between the build chamber and the powder storage container, the powder overflow container, and/or the building container, according to a completion of additive manufacturing. The cleaning element may extend in the reception at least partially in the longitudinal direction of the cylindrical base body of the blade turret.

According to the completion of additive manufacturing, the blade turret can rotate and switch to the cleaning element so that it faces the bottom of the build chamber. The cleaning element can thus remove the powder residue and/or weld spatter from the bottom of the build chamber and/or the interface between the build chamber and the containers. In this way, it can be ensured that no powder residue can be carried away during the removal of the containers.

In one embodiment, the blade turret has at least one further reception into which an illumination element can be inserted for illuminating the powder layer for the reception of the image data. The illumination element may comprise at least one illumination means, such as LED, halogen, laser, neon, xenon lamp, etc. Preferably, the illumination means may comprise NIR (near infrared) LEDs.

The illumination means may be used to illuminate a build area that is currently being traversed by the blade device. Preferably, the illumination element may fully illuminate the entire build area. The illumination element may extend at least partially in the longitudinal direction of the blade turret in the reception. The illumination element can be positioned in such a way that a defective powder application causes a shadow cast on the powder layer, which is detected by the optical element mounted above the build field. In this way, the optical device can provide reliable off-axis monitoring of the building panel and/or the freshly applied powder layer. For example, the emission range of the LED may be 850 nm.

Additionally and/or alternatively, the blade device may comprise at least one illumination element arranged on the carrier body of the blade device preferably on a lower side of the blade device in the direction of travel and/or in the opposite direction of travel of the blade device in order to illuminate the entire build field without gaps. In one embodiment, the optical element is an off-axis camera with a filter device for capturing image data only with wavelengths between 820 and 870 nm, preferably 830 to 860 nm. The optical element may include in the build chamber at least one or two high resolution multifunctional cameras with high spectral bandwidth capable of capturing thermal process emissions during additive manufacturing using the filter device, i.e. optical bandpass filters.

A basic prerequisite for high workpiece quality can be a defect-free powder application during additive manufacturing. Typical error patterns can be locally insufficient powder application or scoring in the powder bed, which can be caused, for example, by local defects in the blade device. In order to prevent possible powder application errors, the freshly applied powder layer can be inspected optically.

The off-axis camera can be located in the build chamber and, due to the bandpass filter used for off-axis thermography, record signals exclusively in the wavelength range between 820 and 870 nm, preferably 830 to 860 nm. The illumination means integrated in the blade turret, e.g. NIR LED, can be used to illuminate the freshly applied powder layer. The illumination means can be positioned in such a way that a faulty powder application causes a shadow cast on the powder layer, which is detected by the optical device mounted above the construction field.

Since the blade device can only illuminate a part of the build area and/or the powder layer, the off-axis camera operates with a long exposure time. The exposure time of the off-axis camera can be adapted to the time taken for the blade device to pass over the building panel. The build chamber can therefore be configured in such a way that no disturbing light signals from outside can enter the build chamber. The off-axis camera can only capture the reflected light from the powder bed surface. Since the fresh powder application, as well as the illumination, passes through the movement of the blade device at a constant speed, a uniformly illuminated reception is obtained during the long exposure by the off-axis camera.

In one embodiment, the off-axis camera may be designed for laser calibration and/or build chamber calibration. Due to increased temperature inside the build chamber during the melting process, thermal strains of the build chamber, the building panel and/or the galvo motors in the scanner (e.g. gaindrift and offset drift) cannot be avoided.

Camera calibration may require a calibration plate on which a specific cross pattern is applied with high precision and extreme accuracy (accuracy <1 μm). This plate can be placed in the build chamber before the start of additive manufacturing so that the pattern is exactly in the expected process plane. The blade device moves over the calibration plate with the illumination means turned on, allowing the off-axis camera to create a high-resolution image of the plate.

Since the camera can be positioned slightly obliquely and not absolutely vertically above the build area, the camera image can be rectified from the build area (from trapezoidal to rectangular). A software program stored in the control unit can capture the (cross) pattern from the calibration plate image and rectify it. According to the completion of the image rectification, all receptions with the off-axis camera can now be created without distortion. The camera can thus be considered calibrated.

If the scan field distortion is pronounced, dimensional accuracy losses can occur, so that scan field rectifications are necessary. Precise camera calibration of the off-axis camera can be a basic requirement for successful implementation of scan field alignment as well as scan field rectification.

For this purpose, the scanner can laser a test pattern consisting of, for example, 11×11 crosses whose main axes run diagonally to the reference coordinate system onto the bare building panel or onto an anodized aluminum panel. The off-axis camera can record the scan pattern in the process. The control unit can use the off-axis reception to calculate the exact intersection point of the two main axes of the lasered crosses. Using the calibrated camera, the control unit can now check whether ACTUAL positions of the crossing points deviate from the TARGET positions. A possible deviation from the TARGET positions can be transferred to the control unit, such as scanner software, which calculates a new correction file from this data and returns it to the scanner. This procedure can be done with any scanner.

During scan field alignment, the field as a whole can drift. With a single beam system, this drift is hardly noticeable. In a multi-beam system, however, the drifts of two scanners can add up, so that the total drift—especially when a workpiece is produced together—can lead to microporosities that have a negative effect on the resulting workpiece quality. Due to the thermal influences on positional accuracy of the lasers on the build area, which cannot be eliminated, permanent scan field alignment can be almost essential.

In order to align two or more scan fields with each other, two support points—the intersection points of two crossing vectors—can be used. A scanner can laser two crosses (or intersection points) onto the field and check whether the intersection points deviate from the expected coordinate. If there is a deviation, the scan field can be rotated and/or moved back to the predetermined position. This procedure can be done for each scanner. Scan field alignment can also be performed during additive manufacturing. For this purpose, the software program can analyze a surface of the current layer to be scanned and, where possible, place two crosses on an area of the already irradiated surface according to the completion of a fusion process.

In one embodiment, the blade device comprises a carrier body and the carrier body and/or the blade turret comprises an interchangeable mechanism element for releasably attaching the blade turret to the carrier body. The interchangeable mechanism element may provide for easy and quick removal of the blade turret from the blade device support body. The change mechanism element may have a positive, friction, (electro-) magnetic and/or clamping connection. In this way, the blade turret can be easily and quickly replaced without much effort.

In one embodiment, the carrier body and/or the blade turret comprises a fastening element for releasably fastening a container lid of a building container and/or a powder container.

To maintain an inert atmosphere within the build and powder containers, the containers are to be handled outside of the additive manufacturing system with only the container lids attached. Inside the build chamber, the container lids cannot be removed until the build chamber is inert. As soon as the inert gas atmosphere is present and the residual oxygen content is below a target threshold, the container lids of the build and powder containers can be removed by means of the blade device.

For this purpose, the blade device can move over the lid of the building container or powder container. At the same time, the carrier body and/or the blade turret can positively grip the container lid by means of the fastening element, which is designed, for example, like a T-shaped groove, via a connecting element located thereon, which is designed, for example, like a T-shaped projection. However, the fastening element and the connecting element can have a different shape in pairs so that they can be engaged in a form-fitting, releasable manner. In this way, the container lids of the building container and/or powder container can be properly removed from the corresponding container.

In one embodiment, the carrier body and/or the blade turret comprises a height adjustment element for height mobility of the held container lid. The height adjustment element can raise the container lid, which has been removed from either the powder container or the building container, to ensure contactless transport of the lid with the building container.

To prevent the container lid from detaching from the carrier body and/or blade turret during transport to a storage location, it is held in place by a cam located in the blade turret. The cam may be arranged in an opposite direction relative to the direction of insertion of the lid. In this way, the container lid cannot slide out of the T-slot during reception, for example, via the blade device, but its movement is restricted by the cam. The storage location may be within the build chamber, but outside the build area.

In one embodiment, the additive manufacturing system further comprises a distance sensor for sensing a distance between the building panel and the coater element. The distance sensor may preferably be arranged on a bottom side of the blade device facing the building panel. The manufacturing system and/or the blade device may include a plurality of distance sensors to enable precise measurement of the distance between the building panel and the coater element. The distance sensor may further be configured to measure the distance between the coater element and a base plate of the powder container to accurately determine the amount of powder material present in the powder container.

For example, the distance sensor may be an inductive sensor, an ultrasonic sensor, or a radar sensor that provides non-contact distance measurement.

In one embodiment, the additive manufacturing system further comprises a contact sensor for detecting a contact between the building panel and the coater element. The contact sensor may preferably be disposed on the bottom side of the blade device facing the building panel. The contact sensor can be a tactile contact sensor that can come into direct contact with the building panel.

Prior to the start of additive manufacturing, the building panel can be lifted to the bottom of the build chamber using the lifting device. The blade device can travel over the building panel and the contact sensor can sense contact with the building panel at multiple locations. To facilitate this, the manufacturing system or blade device may have two or more contact sensors that may be spaced apart on the bottom side of the blade device. In this way, a position of the building panel, in particular height and inclination relative to a horizontal plane can be precisely detected and corrected according to the measurement results.

In one embodiment, the optical device further comprises an on-axis sensor arranged in a beam path for irradiating the powder layer to detect process emissions from a molten bath region when irradiating the powder layer. The on-axis sensor may include a ratio pyrometer, photodiodes, and/or a high-speed camera designed to detect the temperature of the powder bath. The building panel within the building container may contain the powder bath surrounding workpieces created by the selective melting process.

The ratio pyrometer may be designed to detect the maximum temperatures in the powder bath. The high-speed camera can be used to detect a powder bath shape and a distribution of a heat radiation intensity in the powder bath, which can contribute to an improved overall understanding of the process. The photodiodes can also be used to detect the heat radiation in the molten bath or powder bath.

In this way, precise detection of thermal process emissions in the build chamber can be realized, thereby fulfilling a requirement for real-time control of additive manufacturing.

The present disclosure further comprises an additive manufacturing process comprising the following steps, not necessarily in this order:

S1 Applying or removing a powder material to or from a building panel using a blade device having at least one coater element,

S2 acquiring image data from the building panel and/or from the powder layer by means of an optical device having an optical, and

S3 raising and/or lowering the building panel by means of a lifting device, wherein the lifting device is controlled by a control unit based on the image data.

In this way, a proper operation of additive manufacturing can be ensured and the productivity of additive manufacturing can be increased. In particular, real-time control of the manufacturing system can be realized by parallel monitoring of the additive manufacturing.

In one embodiment, the additive manufacturing process may comprise aligning the building panel by means of at least one contact sensor. For this purpose, the building panel may be lifted to the bottom of the build chamber by means of the lifting device. The contact sensor can thereby detect contact with the building panel at several points. In this way, a position of the building panel, in particular height and inclination relative to a horizontal plane, can be precisely detected and corrected according to the measurement results.

The building panel can then be lowered slightly more than 3 mm below the calculated building panel position (level 0) on contact. Thus, the building panel can be minimally below level 0. Level 0 can, for example, be the position of a floor of the building chamber, to which the powder container, the building container and/or the overflow container can be coupled. In this way, it can be ensured that the blade device does not come into contact or collide with the building panel during operation, as the coater element can be located approximately 0.05 mm above level 0.

In one embodiment, steps S1 (ablation), S2 (image data acquisition) and S3 (lifting) are repeated until the evaluation shows that the building panel is essentially free of powder. In this case, a determination of the position of the coating element relative to the building panel follows as a reference position for this coating element.

According to the alignment of the building panel, the optical element can create a reference image of the building panel still untouched by the powder material. In the following step, the coating element can apply a powder layer to the building panel. This powder layer, insofar as the position of the building panel is not changed according to the alignment of the building panel, can have an average thickness of about 0.2+0.1 mm. According to the application of the powder layer, the building panel can be raised by an amount of 10-100 μm.

The blade device can then remove part of the raised powder layer, and at the same time a photo of the powder situation on the building panel can be taken by the optical element. After the powder layer has been removed, an image-processing algorithm can check, based on the reference image, whether the building panel is still completely covered with powder or whether building panel areas already untouched by powder are showing through.

If the algorithm confirms the building panel is still completely covered with the powder material, steps S1 to S3 can be repeated with the removal of a 10-100 μm thick powder layer. These steps can be repeated until the optical element, i.e. off-axis camera and associated algorithm detects minimal residue of powder material on the building panel. Ideally, the position of the building panel can be set as the start position of additive manufacturing when only a few areas of the building panel are still covered with the powder material.

The manufacturing system, preferably the control unit, can then detect and store the exact horizontal position of the building panel in conjunction with the coater element to be used. For the remaining coater elements in the blade turret, the steps described above can be repeated to determine an optimal position of the building panel for each coater element. If the exact vertical position of the building panel is known for each coater element within the blade turret, it has the advantage that all available coater elements can be used perfectly during ongoing additive manufacturing. If the coater element is changed during operation, the manufacturing system may only be able to make minor corrections to the vertical position in order to adopt the coater element-specific optimal position.

In one embodiment, the acquisition of image data is limited to wavelengths between 820 and 870 nm, preferably 830 to 860 nm. Visible light and/or laser radiation is masked out. In one embodiment, the additive manufacturing process further comprises illuminating the powder layer with wavelengths between 820 and 870 nm, preferably 830 to 860 nm when recording image data in step S2. In other words, the optical element, i.e. the off-axis camera may comprise a filter device for capturing image data only with wavelengths between 820 and 870 nm, preferably 830 to 860 nm.

The illumination means integrated in the blade device, e.g. NIR LED strip, can be used to illuminate the freshly applied powder layer. The illumination means can be positioned in such a way that a faulty powder application provokes a shadow cast on the powder layer, which is detected by the optical device mounted above the build chamber.

The build chamber can therefore be configured so that no interfering light signals can enter the build chamber from outside. The off-axis camera can only detect the reflected light from the powder bed surface. Since the fresh powder application, as well as the illumination, passes through the movement of the blade device at a constant speed, a uniformly illuminated reception is obtained during the long exposure by the off-axis camera.

In one embodiment, the additive manufacturing process further comprises releasably connecting the blade device to a container lid of a building container and/or a powder container and transporting the container lid to a storage location using the blade device.

To maintain an inert atmosphere within the build and powder containers, the containers should be handled outside of the additive manufacturing system with only the container lids attached. Inside the build chamber, the container lids cannot be removed until the build chamber is inert. As soon as the inert gas atmosphere is present and the residual oxygen content is below a target threshold, the container lids of the build and powder containers can be removed by means of the blade device.

For this purpose, the blade device can move over the lid of a container. At the same time, the carrier body and/or the blade turret can positively grip the container lid by means of the fastening element, which is designed, for example, like a T-shaped groove, via the connecting element located thereon, which is designed, for example, like a T-shaped projection. In this way, the container lids of the building container and/or powder container can be removed from the corresponding container without any problems.

The container lid picked up by the blade device can be raised from the bottom of the build chamber by means of a height adjustment element, to ensure contactless transport of the lid with the build chamber. By moving the blade device horizontally, the container lid can be transported to the storage location. The storage location for the container lid can be inside the build chamber, but outside the build field.

Further features, advantages and possible applications of the present disclosure will be apparent from the following description, embodiments and figures. All features described and/or illustrated may be combined with each other, irrespective of their representation in individual claims, figures, sentences or paragraphs. In the figures, identical reference signs stand for identical or similar objects.

### BRIEF DESCRIPTION OF THE FIGURES

FIG. 1 shows a manufacturing system for additive manufacturing of a workpiece according to an embodiment.

FIG. 2 shows a blade device of a manufacturing system for additive manufacturing of a workpiece according to an embodiment.

FIG. 3 shows a manufacturing system for additive manufacturing of a workpiece according to an embodiment.

FIG. 4 shows a manufacturing system for additive manufacturing of a workpiece according to an embodiment.

FIG. 5 shows a manufacturing system for additive manufacturing of a workpiece according to an embodiment.

FIG. 6 shows a manufacturing system for additive manufacturing of a workpiece according to an embodiment.

FIG. 7 shows a flow diagram of an additive manufacturing process.

### DETAILED DESCRIPTION OF THE EMBODIMENTS

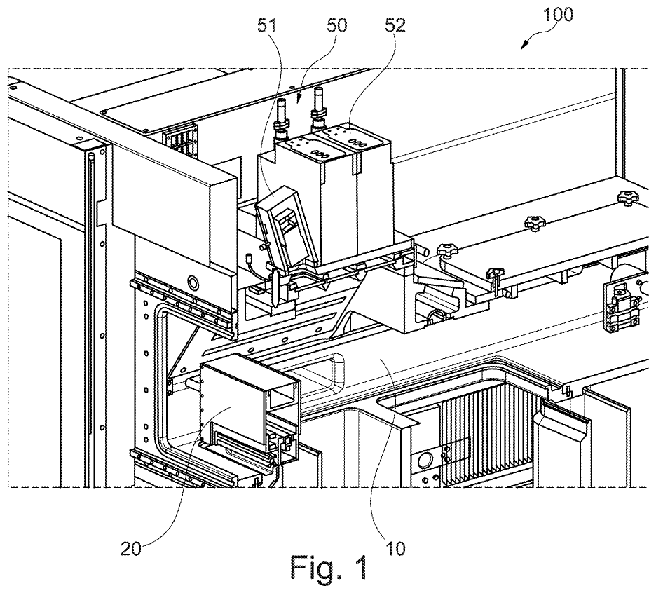

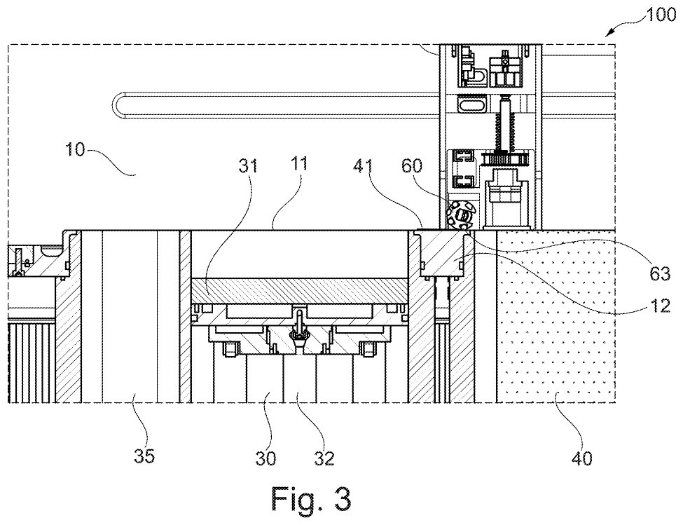

FIG. 1 shows a manufacturing system 100 for additive manufacturing of a workpiece. The manufacturing system 100 comprises a building chamber 10 to which a building container 30 and a powder container 40 can be coupled (see also FIG. 3). The powder container 40 is configured to store powder material 41 and the building container 30 is configured to perform additive manufacturing of a workpiece on a building panel 31 located in the building container 30.

The build chamber 10 includes an opening sealed, for example, by an optically transparent material. Through this opening, the laser beam can be provided to expose a fresh powder layer applied to the building panel 31.

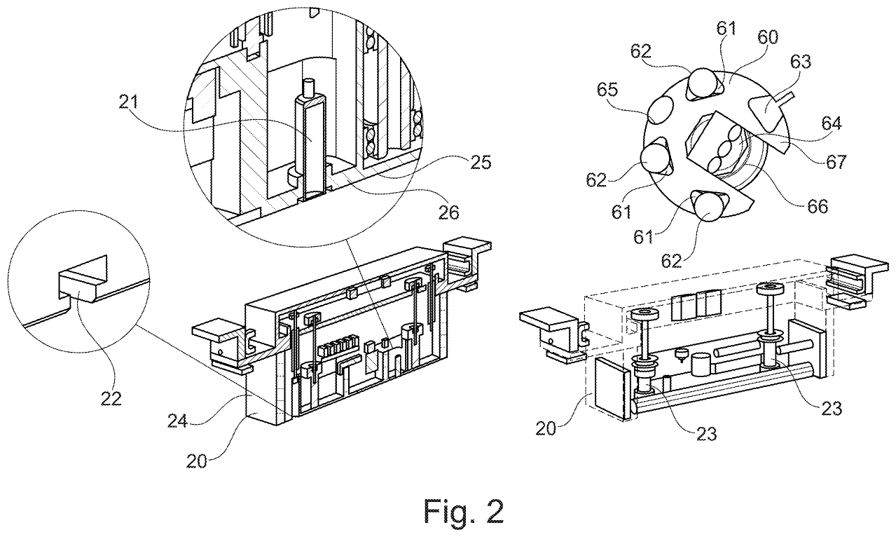

A blade device 20 is located in the building container 10 to layer the fresh powder material 41 from the powder container 40 onto the building panel 31 of the building container 30, and to discharge the excess residual powder material from the building panel 31 into a powder overflow container 35 (see also FIG. 2).

The manufacturing system 100 further comprises an optical device 50 comprising an off-axis optical element 51 and at least one on-axis sensor 52. The off-axis optical element 51 may comprise, for example, an off-axis camera. The off-axis optical element 51 is configured for reception of image data from the building panel and/or from the powder layer. The off-axis camera 51 includes a filter device configured to capture image data only at wavelengths between 820 and 870 nm, preferably 830 to 860 nm. The on-axis sensor 52 may comprise, for example, a ratio pyrometer. The on-axis sensor 52 is arranged in a beam path for irradiating the powder layer in order to detect process emissions from a melt pool region during irradiation of the powder layer.

FIG. 2 shows the blade device 20 of the additive manufacturing system 100. The blade device 20 comprises a blade turret 60 having a cylindrical base body 67, the peripheral surface of which has at least one reception 61 into which a coater element 62 is inserted. The coater element 62 is configured for applying or removing powder material 41 to or from the building panel 31 of the building container 30. Preferably, the blade turret 60 has a plurality of receptacles 61 into which additional coater elements 62 are inserted. The coater element 62 may be a rubber lip or a blade made of metal and/or ceramic.

A cleaning element 63 is positioned in one of the plurality of receptions 61 of the blade device 60, which is configured to remove powder residues according to the additive manufacturing of the workpiece. The cleaning element 63 may be, for example, a silicone impregnated brush and/or a carbon brush.

As shown in FIG. 3, the cleaning element 63 can clean an interface 12 between a bottom 11 of the build chamber 10 and the powder container 40, the powder overflow container 35, and/or the building container 30. According to the completion of additive manufacturing, the blade turret 60 can rotate and switch to the cleaning element 63 so that it faces the bottom 11 of the build chamber 10. The cleaning element 63 can thus remove the powder residue and/or weld spatter from the floor 11 of the build chamber 10 and/or the interface 12 between the floor 11 and the containers 30, 40, 35. In this way, it can be ensured that no powder residue can be carried away during the removal of the containers.

Further, an illumination element 64 is positioned in one of the plurality of receptacles 61 of the blade device 60 and is configured to illuminate the powder layer for reception of the image data. The illumination element 64 comprises at least one illuminant, such as LED, halogen, laser, neon and/or xenon lamp, preferably NIR (Near Infrared)—LED.

The coater element 62, the cleaning element 63 and/or the illumination element 64 extend at least partially in the longitudinal direction of the cylindrical body 67 of the blade turret 60.

The blade device 20 further comprises a support body 24 to which the blade turret 60 is releasably attached by means of an interchangeable mechanism element 66. The interchangeable mechanism element 66 can provide for easy and quick removal of the blade turret 60 from the blade device 20. The interchangeable mechanism element 66 may have a positive connection, a friction connection, an (electro)magnetic connection, and/or a clamping connection.

The blade device 20 further comprises at least one distance sensor 21 for detecting a distance between the building panel 31and the coater element 62. The distance sensor 21 is arranged on a bottom side 26 of the blade device 20 so as to face the bottom 11 of the building chamber 10. Preferably, the blade device 20 includes a plurality of distance sensors 21 to enable precise measurement of the distance between the building panel 31 and the coater element 62.

The distance sensor 21 may further be configured to measure the distance between the coater element 62 and a base plate 43 of the powder container 40 to determine the amount of powder material 41 currently present in the powder container 40. The distance sensor 21 may be, for example, an inductive sensor, an ultrasonic sensor, or a radar sensor that provides a non-contact distance measurement.

The blade device 20 further comprises a contact sensor 25 for detecting a contact between the building panel 31 and the coater element 62. The contact sensor 25 is arranged on the bottom side 26 of the blade device 20 so as to face the building panel 31 of the building container 30.

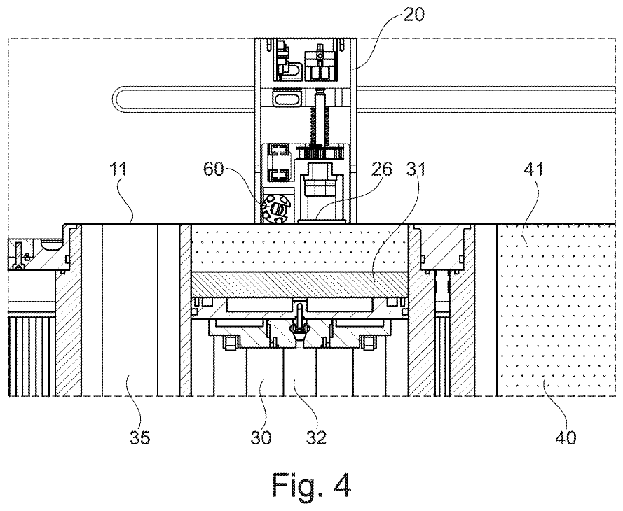

As shown in FIG. 4, the building container 30 is coupled to a lifting device 32 configured to raise and/or lower the building panel 31 within the building container 30. The base plate 43 of the powder hopper 40 may also be coupled to a separate lifting device (not shown) to deliver the fresh powder material 41 to the bottom 11 of the build chamber.

Prior to the start of additive manufacturing, the building panel 31 can be raised to the floor 11 of the build chamber 10 by means of the lifting device 32. During this process, the contact sensor 25 may detect contact with the building panel 31 at a plurality of locations. To facilitate this detection, the blade device 20 may include two or more contact sensors 25 that may be spaced apart from each other on the bottom 26 of the blade device 20. In this way, a position of the building panel 31, in particular height and inclination relative to a horizontal plane can be precisely detected and corrected according to the measurement results.

The blade device 20 further comprises a fastening element 22 for releasably fastening a container lid 33, 42 of the building container 30 and/or the powder container 40 and a height adjustment element 23 for height mobility of the held container lid 33, 42. In order to maintain an inert atmosphere within the building container 30 and powder container 40, the containers 30, 40 are to be handled outside the additive manufacturing system 100 exclusively with the container lids 33, 42 in place.

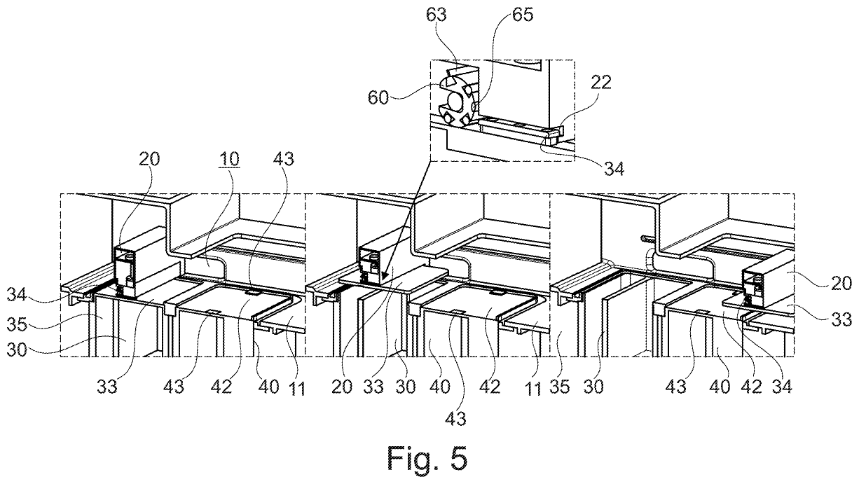

As shown in FIG. 5, according to an insertion of the building container 30 and powder container 40 into the building chamber 10 and an inerting of the building chamber 10, the blade device 20 moves over a container lid 33, 42 of these containers 30, 40. At the same time, the carrier body 24 of the blade device 20 can positively grip the container lid 33, 42 by means of the fastening element 22, which is designed like a T-shaped groove, via a connecting element 34 located thereon, which is designed like a T-shaped projection. Preferably, the blade device 20 comprises at least two fastening elements 22 and the container lid 33, 42 comprises at least two connecting elements 34, 43 in order to be able to lift the lid 33, 42 from respective containers 30, 40 uniformly in the vertical direction.

The height adjustment element 23 can raise the container lid 33, 42, which has been removed from either the powder container 40 or the building container 30, in the vertical direction to ensure contactless transport of the lid 33, 42 with the building field. To prevent the container lid 33, 42 from becoming detached from the blade device 20 during transport, its movement is restricted by a cam 65 arranged in the blade turret 60. The cam 65 may be arranged in an opposite direction relative to the direction of insertion of the lid 33, 42 to the blade device 20. In this manner, the container lid 33, 42 cannot slide out of the fastening element 22 of the blade device 20 during reception, but instead is held in place by the cam 65.

The build container lid 33 and powder container lid 42 removed from the blade device 20 are transported to a storage location (not shown), which is inside the build chamber 10, but outside the build area.

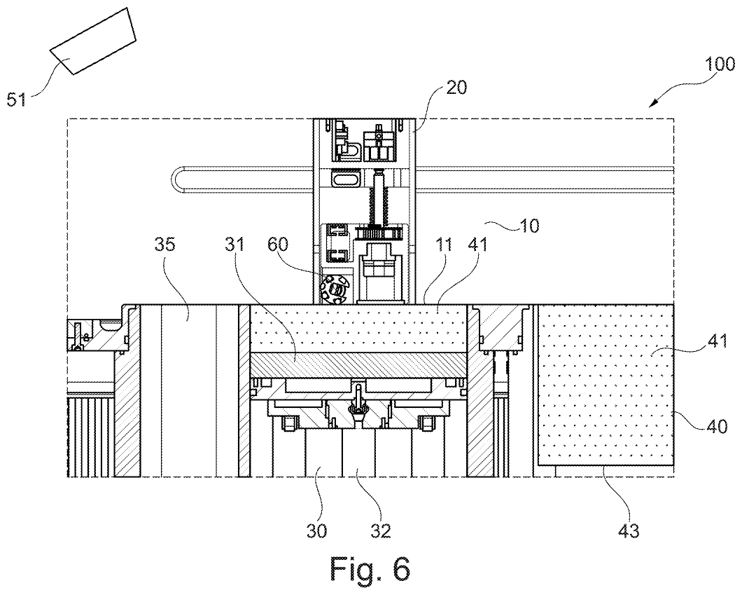

FIG. 6 shows powder application monitoring during additive manufacturing. As the powder material 41 is applied, line-like structures may be formed in the direction of travel of the blade device 20. Visibility of such a powder application defect may increase most when illuminated by side lighting to create a shadow. The powder application defect and/or the coating defect can be detected indirectly via a characteristic shadow using the optical element 51, preferably the off-axis camera.

The control unit (not shown) can detect an application quality of the powder material 41 using the optical device 50, and detect an error on the currently used coating element 62 if the application quality of the powder material 41 deviates from the predetermined requirement. In the event of the defect, the blade turret 60 can rotate according to the severity of the damage to the current coater element 62 and switch to a next coater element 62, particularly one that is free of defects.

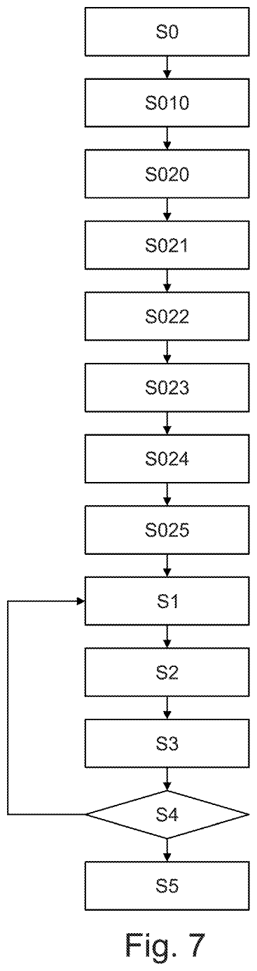

FIG. 7 shows a flowchart of an additive manufacturing process.

In step S0, the building container 30 and the powder container 40 are inserted into the build chamber 10 of the manufacturing system 100, and the build chamber 10 is then inerted to minimize the oxygen content in the build chamber 10.

In step S010, the lid 33 of the building container 30 is removably connected to the fastening element 22 of the blade device 20. The lid 33 is raised by the height adjustment member 23 and transported to the lid storage location by a horizontal movement of the blade device 20.

In step S020, a position of the building panel 31 is aligned. For this purpose, the building panel 31 is lifted S021 to the bottom 11 of the building chamber 10 by means of the lifting device 32. In this process, the contact sensor 25 can detect contact with the building panel 31 at a plurality of locations S022. In this way, a position of the building panel 31, in particular height and inclination relative to a horizontal plane is precisely detected and corrected according to the measurement results S023.

The building panel 31 is then lowered slightly more than 3 mm below the calculated building panel position (level 0) on contact S024. Thus, the building panel 31 can be minimally below level 0. The level 0 can, for example, be the position of a floor 11 of the building chamber 10, to which a powder container 40, a building container 30 and/or a powder overflow container can be coupled. In this way, it can be ensured that the blade device 20 does not come into contact or collide with the building panel 31 during operation, as the coater element can be located approximately 0.05 mm above level 0. According to the alignment of the building panel 31, the optical element 51 creates a reference image of the building panel S025 still untouched by the powder material 41.

In the following step S1, the powder material 41 is applied to the building panel 31 by means of the coating element 62 of the blade device 20. According to the application of the powder layer, the building panel 31 is lifted S2 by an amount of 10-100 μm. The blade device 20 subsequently removes a portion of the lifted powder layer.

In step S3, image data of the powder layer on the building panel 31 is acquired by means of the optical device 50, preferably the off-axis camera 51. In step S31, an image-processing algorithm checks, on the basis of the reference image, whether the building panel 31 is still completely covered with powder or whether building panel areas already untouched by the powder show through.

If S4 the algorithm confirms the building panel 31 is still completely covered with powder material 41, steps S1 to S3 can be repeated with the removal of a 10-100 μm thick layer of powder. These steps can be repeated until the optical element 51, i.e. off-axis camera and associated algorithm detects minimal residue of powder material 41 on the building panel 31. Ideally, the position of the building panel 31 can be set as the start position of additive manufacturing when only a few areas of the building panel 31 are still covered with the powder material 41.

The control unit of the manufacturing system 100 stores S5 the exact horizontal position of the building panel 31 in conjunction with the coater element 62 to be used. For the remaining coater elements 62 in the blade turret 60, the steps described above can be repeated to determine an optimal position of the building panel 31 for each coater element 62.

Supplementally, it should be noted that “comprising” and “comprising” do not exclude other elements or steps. Further, it should be noted that features or steps that have been described with reference to any of the above embodiments may also be used in combination with other features or steps of other embodiments described above. Reference signs in the claims are not to be regarded as a limitation.

1. A manufacturing system for additive manufacturing of a workpiece, comprising
a building panel,
a lifting device for the building panel,
a blade device,
an optical device, and
a control unit,
wherein the blade device comprises at least one coater element for applying or removing a powder material to or from the building panel,
wherein the optical device comprises an optical element for reception of image data from the building panel and/or from the powder layer,
wherein the lifting device is configured to raise and/or lower the building panel, and
wherein the control unit is adapted to control the lifting device based on the image data.

2. The additive manufacturing system according to claim 1, wherein the blade device comprises a blade turret having a cylindrical base body, the peripheral surface of which has at least one reception into which the coater element is inserted.

3. The additive manufacturing system according to claim 2, wherein the blade turret has at least one further reception into which a further coater element to be inserted.

4. The additive manufacturing system according to claim 2, wherein the blade turret has at least one further reception, into which a cleaning element for removing powder residues to be inserted.

5. The additive manufacturing system according to claim 2, wherein the blade turret having at least one further receptacle into which an illumination element for illuminating the powder layer to be inserted for reception of the image data.

6. The additive manufacturing system according to claim 1, wherein the optical element is designed an off-axis camera with a filter device for capturing image data only with wavelengths between 820 and 870 nm.

7. The additive manufacturing system according to claim 1, wherein the blade device comprises a support body and the support body and/or the blade turret comprises an interchangeable mechanism element for releasably attaching the blade turret to the support body.

8. The additive manufacturing system according to claim 7, wherein the carrier body and/or the blade turret comprises a fastening element for releasably fastening a container lid of a building container and/or a powder container.

9. The additive manufacturing system according to claim 8, wherein the carrier body and/or the blade turret comprises a height adjustment element for height mobility of the held container lid.

10. The additive manufacturing system according to claim 1, further comprising a distance sensor for detecting a distance between the building panel and the coater element.

11. The additive manufacturing system according to claim 1, further comprising a contact sensor for detecting a contact between the building panel and the coater element.

12. The additive manufacturing system according to claim 1, wherein the optical device further comprises at least one on-axis sensor disposed in a beam path for irradiating the powder layer to detect process emissions from a molten bath region when irradiating the powder layer.

13. An additive manufacturing process, comprising:
S1 applying or removing a powder material to or from a building panel using a blade device having at least one coater element,
S2 recording image data from the building panel and/or from the powder layer by means of an optical device having an optical element, and
S3 lifting and/or lowering the building panel by means of a lifting device, wherein the lifting device is controlled by a control unit based on the image data.

14. The additive manufacturing method according to claim 13, wherein the steps S1 (removing), S2 (recording image data) and S3 (lifting) are repeated until the evaluation shows that the building panel is substantially free of powder, and in this case, setting the position of the coating element relative to the building panel as a reference position for this coating element.

15. The additive manufacturing method according to claim 13, wherein recording of image data is limited to wavelengths between 820 and 870 nm, and visible light and/or laser radiation is masked out.

16. The additive manufacturing method according to claim 13, further comprising illuminating the powder layer with wavelengths between 820 and 870 nm, when recording image data in step S2.

17. The additive manufacturing method according to claim 13, further comprising releasably connecting the blade device to a container lid of a building container and/or a powder container and transporting the container lid to a storage location by means of the blade device.

18. The additive manufacturing system according to claim 6, wherein the wavelengths are between 830 to 860 nm.

19. The additive manufacturing method according to claim 15, wherein the wavelengths are between 830 to 860 nm.

20. The additive manufacturing method according to claim 16, wherein the wavelengths are between 830 to 860 nm.
